(19) United States
(12) Patent Application Publication
(10) Pub. No.: US 2026/0249759 A1
(43) Pub. Date: Aug. 27, 2026

(54) CHILD SEAT UNDERLAY WITH ANCHOR GUIDE

(71) Applicant: Wonderland Switzerland AG, Steinhausen (CH)

(72) Inventors: Bruce L. Williams, Morgantown, PA (US); Gregory S. Sellers, Morgantown, PA (US); Steven G. Gerhart, Morgantown, PA (US); Brad Bickley, Morgantown, PA (US); Samuel Gearhart, Glenside, PA (US); Colin F. Eggert-Crowe, King of Prussia, PA (US)

(21) Appl. No.: 19/489,699

(22) PCT Filed: May 17, 2024
(86) PCT No.: PCT/US2024/029959

§ 371 Date: Dec. 3, 2025

Related U.S. Application Data
(60) Provisional application No. 63/506,512, filed on Jun. 6, 2023.
(60) Provisional application No. 63/511,233, filed on Jun. 30, 2023.
(60) Provisional application No. 63/644,020, filed on May 8, 2024.

(51) Int. Cl. B60N 2/60; B60N 2/28

(52) U.S. Cl. CPC B60N 2/6018; B60N 2/2821; B60N 2/2893

(57) ABSTRACT

A child seat underlay is positionable on a vehicle seat with a vehicle anchor. The child seat underlay upon which a child seat including an anchor system is positionable includes a body positionable to overlap a surface of the vehicle seat and at least one anchor guide associable with the body. The at least one anchor guide is connectable to the vehicle anchor of the vehicle seat.

### CROSS REFERENCE TO RELATED APPLICATIONS

This application claims the benefit of U.S. Application No. 63/506,512, filed on Jun. 6, 2023, and U.S. Application No. 63/511,233, filed on Jun. 30, 2023, and U.S. Application No. 63/644,020, filed on May 8, 2024, which is incorporated herein by reference in its entirety.

### BACKGROUND

Exemplary embodiments of the disclosure relative to child safety seat for use in a vehicle, and more particularly, to a child seat underlay used in combination with a child safety seat.

Positioning a child seat in direct contact with a vehicle seat can damage, deform, or wear the material of the vehicle seat over time. To protect the vehicle seat, a child seat underlay can be positioned over the surface of the vehicle seat, between the child seat and the vehicle seat. To properly install a child seat within a vehicle, anchors extending from the child seat are typically connected to vehicle anchors embedded within the vehicle seat. However, when a child seat underlay is present on the surface of the vehicle seat, between the child seat and the vehicle seat, connecting the anchors of the child seat to the vehicle anchors can be more difficult.

### BRIEF DESCRIPTION

According to some embodiment, a child seat underlay is positionable on a vehicle seat with a vehicle anchor. The child seat underlay upon which a child seat including an anchor system is positionable includes a body positionable to overlap a surface of the vehicle seat and at least one anchor guide associable with the body. The at least one anchor guide is connectable to the vehicle anchor of the vehicle seat.

In addition to one or more of the features described above, or as an alternative, in further embodiments the body includes an underlay seat portion. The underlay seat portion being positionable on a horizontal seat portion of the vehicle seat.

In addition to one or more of the features described above, or as an alternative, in further embodiments an end of the underlay seat portion extends beyond a front edge of the horizontal seat portion of the vehicle seat.

In addition to one or more of the features described above, or as an alternative, in further embodiments the at least one anchor guide is mounted at a rear end of the underlay seat portion.

In addition to one or more of the features described above, or as an alternative, in further embodiments the body includes an underlay back portion positionable adjacent to a seat back of the vehicle seat.

In addition to one or more of the features described above, or as an alternative, in further embodiments the underlay back portion is permanently connected to the underlay seat portion.

In addition to one or more of the features described above, or as an alternative, in further embodiments the underlay back portion is removably couplable to the underlay seat portion.

In addition to one or more of the features described above, or as an alternative, in further embodiments the at least one anchor guide is mounted at an interface between the underlay seat portion and the underlay back portion.

In addition to one or more of the features described above, or as an alternative, in further embodiments the at least one anchor guide is permanently attached to the body.

In addition to one or more of the features described above, or as an alternative, in further embodiments the at least one anchor guide is removably connectable to the body.

In addition to one or more of the features described above, or as an alternative, in further embodiments the body includes at least one opening and the at least one anchor guide is insertable into the at least one opening.

In addition to one or more of the features described above, or as an alternative, in further embodiments the at least one anchor guide includes a mounting flange. The mounting flange is positionable against the body surrounding the at least one opening.

In addition to one or more of the features described above, or as an alternative, in further embodiments the at least one anchor guide includes an anchor guide body having a hollow interior. The hollow interior is dimensioned to receive an anchor of the anchor system extending from the child seat.

In addition to one or more of the features described above, or as an alternative, in further embodiments the child seat is an infant car seat.

In addition to one or more of the features described above, or as an alternative, in further embodiments the child seat is a toddler seat.

In addition to one or more of the features described above, or as an alternative, in further embodiments the child seat is a booster seat.

In addition to one or more of the features described above, or as an alternative, in further embodiments the child seat includes a support base. The anchor extends from the support base.

In addition to one or more of the features described above, or as an alternative, in further embodiments the anchor guide body includes a first guide sidewall and a second guide sidewall spaced from the first guide sidewall. Each of the first guide sidewall and the second guide sidewall has an anchor opening for receiving the vehicle anchor of the vehicle seat.

The child seat underlay of claim 1, further comprising at least one light arranged at one or more of the at least one anchor guide and the body.

In addition to one or more of the features described above, or as an alternative, in further embodiments the at least one light is automatically activatable in response to an input from a sensor. The sensor is arranged at the body.

In addition to one or more of the features described above, or as an alternative, in further embodiments the sensor is a pressure sensor.

In addition to one or more of the features described above, or as an alternative, in further embodiments the sensor is a proximity sensor.

In addition to one or more of the features described above, or as an alternative, in further embodiments the at least one light is manually operable.

According to some embodiments, an anchor guide for use with an anchor system of a child seat is positionable on a vehicle seat with a vehicle anchor. The anchor guide includes a transverse member having a plurality of openings and at plurality of walls extending from the transverse member adjacent to each of the plurality of openings. At least some of the plurality of walls are connectable to the vehicle anchor of the vehicle seat.

In addition to one or more of the features described above, or as an alternative, in further embodiments the plurality of walls includes a first guide sidewall associated with each of the plurality of openings. The first guide sidewall is connectable to the vehicle anchor of the vehicle seat.

In addition to one or more of the features described above, or as an alternative, in further embodiments the first guide sidewall associated with each of the plurality of openings includes an anchor opening for receiving the vehicle anchor of the vehicle seat.

In addition to one or more of the features described above, or as an alternative, in further embodiments an end of the first guide sidewall associated with each of the plurality of openings is contoured to facilitate positioning of the vehicle anchor therein.

In addition to one or more of the features described above, or as an alternative, in further embodiments the plurality of walls further includes second guide sidewall and at least one connecting wall extending between the first guide sidewall and the second guide sidewall.

In addition to one or more of the features described above, or as an alternative, in further embodiments a configuration of the first guide sidewall is different than a configuration of the second guide sidewall.

In addition to one or more of the features described above, or as an alternative, in further embodiments a cross-sectional area of each opening of the plurality of openings varies over a length of the opening.

In addition to one or more of the features described above, or as an alternative, in further embodiments the cross-sectional area of each of the plurality of openings reduces in a direction extending away from the transverse member.

In addition to one or more of the features described above, or as an alternative, in further embodiments the anchor guide is symmetrical about a center line.

In addition to one or more of the features described above, or as an alternative, in further embodiments at least one light is arranged adjacent to at least one of the plurality of openings.

In addition to one or more of the features described above, or as an alternative, in further embodiments the at least one light is automatically activatable in response to an input from a sensor.

In addition to one or more of the features described above, or as an alternative, in further embodiments the sensor is a pressure sensor.

In addition to one or more of the features described above, or as an alternative, in further embodiments the sensor is a proximity sensor.

In addition to one or more of the features described above, or as an alternative, in further embodiments the at least one light is manually operable.

According to an embodiment, a vehicle seat protector is positionable between a child seat and a vehicle seat, the vehicle seat protector includes an underlay seat portion configured to align with and receive a bottom of the child seat, an underlay back portion configured to extend along a seat back of the vehicle seat, an attachment assembly for connecting the underlay back portion to the vehicle seat, and a top guard extending from the underlay back portion, wherein the top guard is positionable to protect the vehicle seat from the attachment assembly.

In addition to one or more of the features described above, or as an alternative, in further embodiments the underlay seat portion has a raised edge extending about its periphery and the bottom of the child seat is receivable within a recess defined by the raised edge.

In addition to one or more of the features described above, or as an alternative, in further embodiments the underlay back portion includes a central portion and the central portion is raised relative to an adjacent surface of the underlay back portion.

In addition to one or more of the features described above, or as an alternative, in further embodiments a width of the top guard is less than a width of the underlay back portion.

In addition to one or more of the features described above, or as an alternative, in further embodiments the top guard is configured to align with an arm of a headrest of the vehicle seat.

In addition to one or more of the features described above, or as an alternative, in further embodiments a connecting member couples the underlay seat portion and the underlay back portion.

In addition to one or more of the features described above, or as an alternative, in further embodiments the connecting member is integrally formed with at least one of the underlay seat portion and the underlay back portion.

In addition to one or more of the features described above, or as an alternative, in further embodiments a material of the connecting member is different than a material of at least one of the underlay seat portion and the underlay back portion.

In addition to one or more of the features described above, or as an alternative, in further embodiments at least one of the underlay seat portion and the underlay back portion is formed from a thermoformed fabric.

In addition to one or more of the features described above, or as an alternative, in further embodiments a core is positioned within an interior of the thermoformed fabric.

In addition to one or more of the features described above, or as an alternative, in further embodiments at least one light associated with at least one of the underlay seat portion and the underlay back portion.

In addition to one or more of the features described above, or as an alternative, in further embodiments the at least one light is associated with both the underlay seat portion and the underlay back portion.

In addition to one or more of the features described above, or as an alternative, in further embodiments the at least one light is operable in response to application of a force to at least one of the underlay seat portion and the underlay back portion.

According to an embodiment, a vehicle seat protector is positionable between a child seat and a vehicle seat and the vehicle seat protector includes a body positionable in overlapping arrangement with the vehicle seat. The body includes an underlay seat portion and an underlay back portion. At least one light is mounted about the body.

In addition to one or more of the features described above, or as an alternative, in further embodiments the at least one light includes a plurality of lights spaced about a periphery of the body.

In addition to one or more of the features described above, or as an alternative, in further embodiments the at least one light is positioned proximate to an edge of the body.

In addition to one or more of the features described above, or as an alternative, in further embodiments the body includes an attachment assembly for connecting the body to the vehicle seat and the at least one light is positioned proximate to the attachment assembly.

In addition to one or more of the features described above, or as an alternative, in further embodiments the at least one light is positioned at a portion of the body proximate to an anchor of the vehicle seat.

In addition to one or more of the features described above, or as an alternative, in further embodiments the

In addition to one or more of the features described above, or as an alternative, in further embodiments the at least one light is automatically activatable in response to an input from a sensor. The sensor is arranged at the body.

In addition to one or more of the features described above, or as an alternative, in further embodiments the sensor is a pressure sensor.

In addition to one or more of the features described above, or as an alternative, in further embodiments the sensor is a proximity sensor.

In addition to one or more of the features described above, or as an alternative, in further embodiments the at least one light is manually operable.

In addition to one or more of the features described above, or as an alternative, in further embodiments the at least one light is associated with the body to illuminate an interface between the body and the child seat.

In addition to one or more of the features described above, or as an alternative, in further embodiments the at least one light is oriented toward the child seat.

According to an embodiment, an anchor guide for use with an anchor system of a child seat and associable with a vehicle anchor of a vehicle seat includes a body having a plurality of walls that in combination define a hollow interior. The hollow interior is dimensioned to receive an anchor of the anchor system extending from the child seat. At least one light is arranged at the body and is operable to illuminate at least a portion of the hollow interior of the body.

In addition to one or more of the features described above, or as an alternative, in further embodiments the plurality of walls includes a first guide sidewall and a second guide sidewall spaced from the first guide sidewall. Each of the first guide sidewall and the second guide sidewall has an anchor opening for receiving the vehicle anchor of the vehicle seat.

In addition to one or more of the features described above, or as an alternative, in further embodiments the at least one light is arranged at one or the plurality of sidewalls within the hollow interior.

In addition to one or more of the features described above, or as an alternative, in further embodiments the at least one light is proximate to an end of one or more of the plurality of sidewalls.

In addition to one or more of the features described above, or as an alternative, in further embodiments a mounting flange is arranged at an end of the body.

In addition to one or more of the features described above, or as an alternative, in further embodiments the at least one light is arranged at the mounting flange.

In addition to one or more of the features described above, or as an alternative, in further embodiments the at least one light is automatically activatable in response to an input from a sensor.

In addition to one or more of the features described above, or as an alternative, in further embodiments the sensor is a pressure sensor.

In addition to one or more of the features described above, or as an alternative, in further embodiments the sensor is a proximity sensor.

In addition to one or more of the features described above, or as an alternative, in further embodiments the at least one light is manually operable.

In addition to one or more of the features described above, or as an alternative, in further embodiments the anchor guide is connectable to a child seat underlay.

### BRIEF DESCRIPTION OF THE DRAWINGS

The following descriptions should not be considered limiting in any way. With reference to the accompanying drawings, like elements are numbered alike:

FIG. 1 is a perspective view of a child seat positioned on a child seat underlay according to an embodiment;

FIG. 2 is a perspective view of a child seat underlay according to an embodiment;

FIGS. 3A and 3B are various perspective views of an anchor guide of a child seat underlay according to an embodiment;

FIG. 4A is a schematic side view of an anchor guide permanently attached to a child seat underlay according to an embodiment;

FIG. 4B is a schematic side view of an anchor guide removably positioned within an opening formed in a child seat underlay according to an embodiment;

FIG. 5A is a side perspective view of a child seat having a rigid anchor system positionable on the child seat underlay according to another embodiment;

FIG. 5B is a side view of an anchor of a child seat according to an embodiment;

FIG. 5C is a side perspective view of a child seat having a flexible anchor system positionable on the child seat underlay according to another embodiment;

FIG. 6 is a schematic cross-sectional diagram of an anchor arranged within the hollow interior of an anchor guide according to an embodiment;

FIG. 7A is a front perspective view of an anchor guide according to another embodiment;

FIG. 7B is a side perspective view of the anchor guide of FIG. 7A according to an embodiment;

FIG. 8 is a perspective view of the anchor guide of FIGS. 7A and 7B installed about a vehicle seat according to an embodiment;

FIGS. 9A and 9B are a side and plan view of an anchor system of a child seat arranged within an anchor guide according to an embodiment;

FIG. 10 is a front perspective view of a child seat underlay according to another embodiment;

FIG. 11 is a diagram representing the footprint of various child seats relative to an underlay seat portion of a child seat underlay according to an embodiment;

FIG. 12A is a perspective view of a child seat underlay positioned about a vehicle seat according to an embodiment;

FIG. 12B is a detailed perspective view of a connecting member of the child seat underlay of FIG. 12A according to an embodiment;

FIG. 12C is a plan view of the child seat underlay of FIG. 12A according to an embodiment;

FIG. 13 is a perspective view of a child seat underlay having at least one light according to an embodiment; and

FIG. 14 is a perspective view of another child seat underlay having at least one light according to an embodiment.

### DETAILED DESCRIPTION

A detailed description of one or more embodiments of the disclosed apparatus and method are presented herein by way of exemplification and not limitation with reference to the Figures.

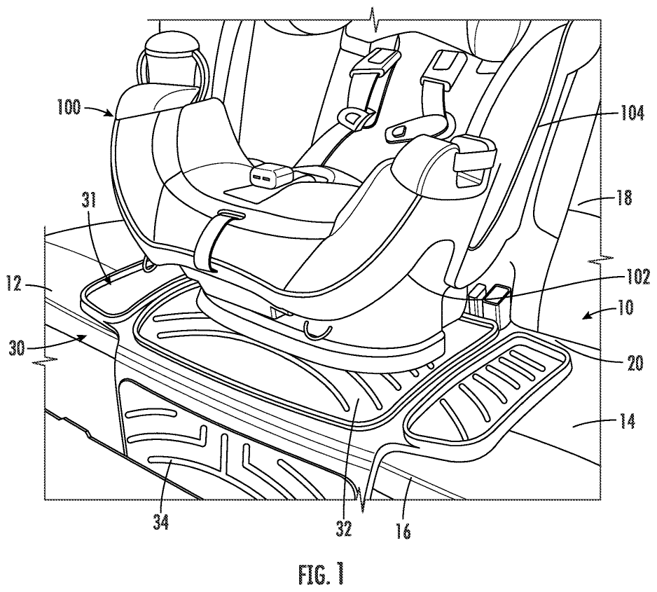

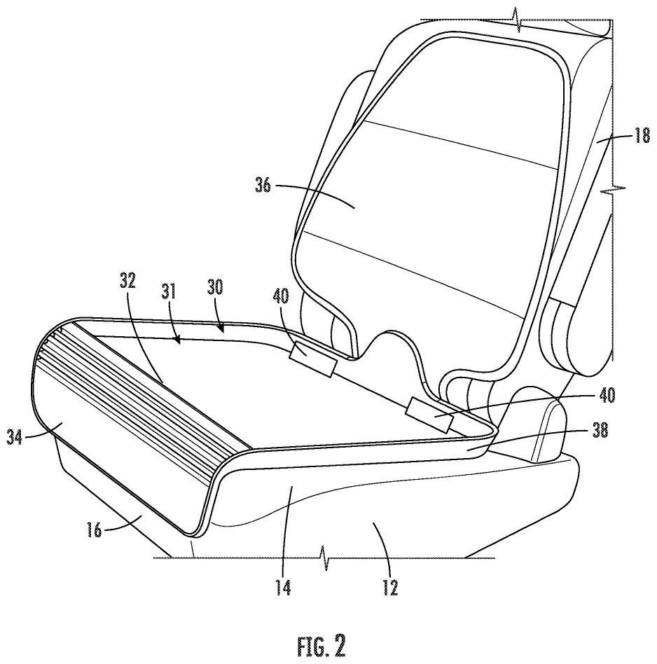

With reference to FIGS. 1 and 2, an example of a vehicle seat protector 30, also referred to herein as a child seat underlay, is illustrated. The child seat underlay 30 is positionable in direct contact with one or more surfaces of a vehicle seat 10 and is typically located at an interface between a child seat 100 and the vehicle seat 10. As used herein, the term “child seat” may refer to an infant car seat, a toddler seat positionable in either a rearward-facing position or a forward-facing position relative to a vehicle seat 10, a booster seat, or a support base associated with any such seat.

The child seat underlay 30 may be formed from a plastic or elastic material, such as rubber for example; however, it will be appreciated that the child seat underlay 30 can be formed from other materials, such as fabric materials for example. In the illustrated, non-limiting embodiment, the child seat underlay 30 includes a body 31 having an underlay seat portion 32 positionable in overlapping arrangement with an upper surface 14 of the generally horizontal seat portion 12 of a vehicle seat 10. The underlay seat portion 32 is typically equal to or larger in size than the seat portion 102 of the child seat 100 receivable thereon. Further, as shown, a front end 34 of the underlay seat portion 32 may extend beyond and overlap a front edge 16 of the vehicle seat 10. However, embodiments where the underlay seat portion 32 does not extend beyond the front edge 16 of the vehicle seat 10 are also contemplated herein.

In some embodiments, shown in FIG. 2, the body 31 of the child seat underlay 30 additionally includes an underlay back portion 36 positionable adjacent to an upright or seat back 18 of the vehicle seat 10. The underlay back portion 36 may be integrally formed with the underlay seat portion 32, or alternatively, may be removably connectable thereto. In such embodiments, when a child seat 100 is installed about the vehicle seat 10, the underlay back portion 36 may be arranged between the seat back 104 of the child seat 100 and the corresponding seat back 18 of the vehicle seat 10.

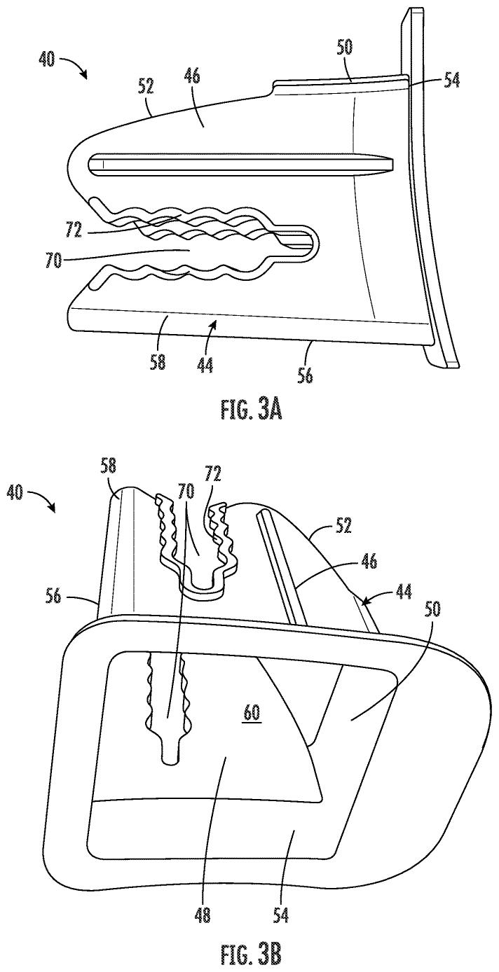

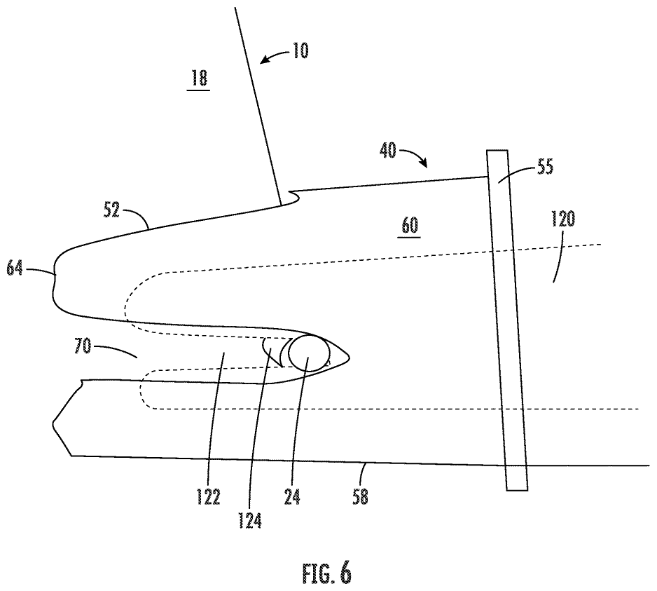

In an embodiment, one or more anchor guides 40 are associated with the body 31 of the child seat underlay 30. An example of an anchor guide 40 is illustrated in more detail in FIGS. 3A and 3B. The at least one anchor guide 40 is positioned about the child seat underlay 30 for connection to a vehicle anchor 24 (FIG. 6), such as located in the seat bight 20 of a vehicle seat 10 arranged at the interface between the seat portion 12 and the seat back 18 of the vehicle seat 10. Accordingly, the one or more anchor guides 40 may be located at a rear end 38 of the underlay seat portion 32, or alternatively, at an interface between the underlay seat portion 32 and the underlay back portion 36.

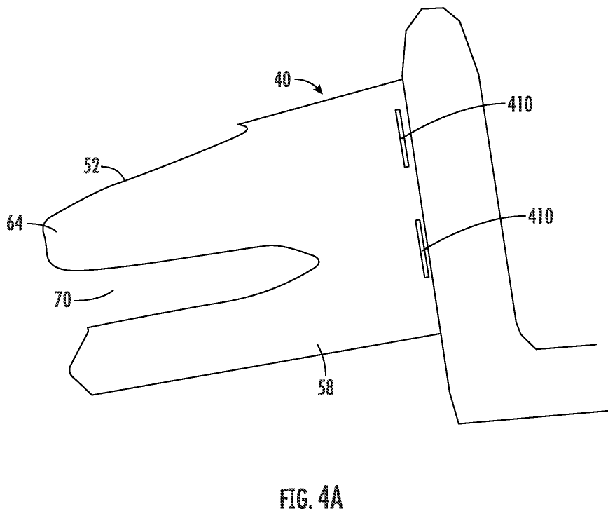

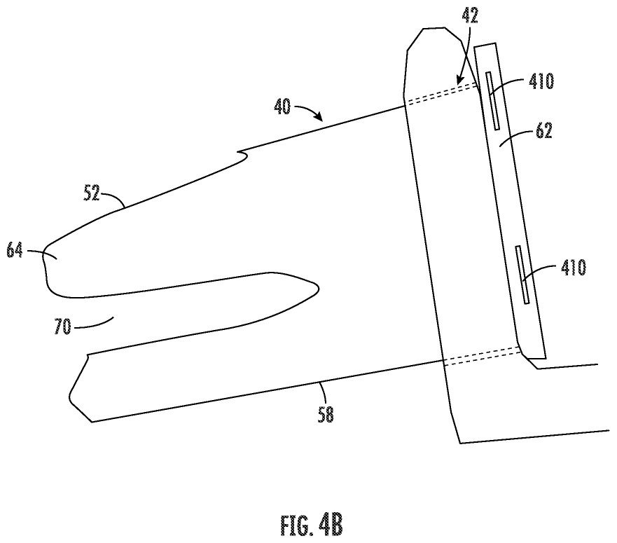

The at least one anchor guide 40 may be permanently affixed to the body 31 as shown in FIG. 4A, or alternatively, may be removably connectable thereto as shown in FIG. 4B. In embodiments where the one or more anchor guides 40 are separable from the body 31 of the child seat underlay 30, such as FIG. 4B, the body 31 of the child seat underlay 30 may include at least one opening 42 for receiving a corresponding anchor guide 40, and the anchor guide 40 may include a flange 62 (to be described in more detail below) that abuts the body 31 and assists in positioning the guide within the opening 42.

With continued reference to FIGS. 3A and 3B, the anchor guide 40 includes an anchor guide body 44 having a first guide sidewall 46 and a second guide sidewall 48 spaced apart from one another. In an embodiment, one or more connecting walls extend between and couple a portion of the first and second guide sidewalls 46, 48. For example, a first connecting wall 50 is connected to an upper surface 52 of the first and second guide sidewalls 46, 48, such as near a first end 54 thereof. As shown, the first connecting wall 50 extends over only a portion of the length of the first and second guide sidewalls 46, 48. Alternatively, or in addition to the first connecting wall 50, a second connecting wall 56 may be connected to a lower surface 58 of the first and second guide sidewalls 46, 48 and may but need not extend over the substantially entire length of the first and second guide sidewalls 46, 48. It should be appreciated that embodiments where the one or more connecting walls 50, 56 extend any suitable length relative to the first and second guide sidewalls 46, 48 are within the scope of the disclosure. The first and second guide sidewalls 46, 48 and in some embodiments the one or more connecting walls 50, 56 cooperate to define a hollow interior 60 of the anchor guide 40.

In embodiments where the anchor guide 40 is removable from the body 31 of the child seat underlay 30, a mounting flange 62 may be arranged at and extend outwardly from the first end 54 of the first guide sidewall 46 and the second guide sidewall 48, and in some embodiments, from the one or more connecting walls 50, 56. The mounting flange 62 may extend a uniform distance in all directions, However, in the illustrated, non-limiting embodiment, a width of the mounting flange 62 extending beyond the first connecting wall 50 is greater than the width of the mounting flange adjacent to the first and second guide sidewalls 46, 48 and/or the second connecting wall 56. In embodiments including a mounting flange 62, the first and second guide sidewalls 46, 48 of the anchor guide 40 are insertable into the opening 42 of formed in the body 31 of the child seat underlay 30. One or more dimensions of the mounting flange 62 are greater than the opening 42 such that the mounting flange 62 abuts and contacts a surface of the body 31 adjacent to or surrounding the opening 42, thereby retaining the anchor guide in position relative to the body 31.

In an embodiment, the anchor guides 40 are operable to selectively couple the child seat underlay 30 to a vehicle seat 10. The first and second guide sidewalls 46, 48 may be substantially identical to one another. As shown, each of the first and second guide sidewalls 46, 48 has an elongated anchor opening 70 for receiving a portion of a vehicle anchor 24 of a vehicle seat 10 therein. One or more surfaces of the anchor opening 70 may be generally smooth, or in some embodiments may be contoured. For example, in the illustrated, non-limiting embodiment, the surfaces of the anchor opening 70 includes a plurality of ridges 72 similar to teeth. Inclusion of such contours may restrict unintended separation of a vehicle anchor 24 from the anchor opening 70.

As shown, the first or upper surface 52 of the first and second guide sidewalls 46, 48 may taper generally downwardly from the first end 54 towards the second, opposite end 64 thereof. Further, the portion of the guide sidewalls 46, 48 extending between the anchor opening 70 and the second end 64 may be contoured to facilitate insertion of the vehicle anchor 24 into the anchor opening 70. In the illustrated, non-limiting embodiment, the second end 64 of the first and second guide sidewalls 46, 48 extending between the upper surface 52 and the anchor opening 70 is generally curved, and the second end 64 of the first and second guide sidewalls 46, 48 extending between lower surface 58 and the anchor opening 70 may be generally sloped or angled. It should be appreciated that embodiments where the second end 64 of a guide sidewall 46, 48 located adjacent to the anchor opening 70 have any suitable contour are within the scope of the disclosure.

When the anchor guide 40 is inserted into the seat bight 20 of a vehicle seat 10, the vehicle anchor 24 is aligned with the anchor opening 70 of the anchor guide 40. As the vehicle anchor 24 slides into the anchor opening 70, towards the first end 54 of the first and second guide sidewalls 46, 48, the adjacent surfaces of the vehicle seat 10 surrounding the seat bight 20 may apply a force to one or both of the upper and lower surface 52, 58 of the first and second guide sidewalls 46, 48. In an embodiment, the anchor guide is formed from a resilient material such that this force pushes the upper and lower surfaces 52, 58 of the first and second guide sidewalls 46, 48 towards one another, thereby reducing the size of the anchor opening 70, and essentially capturing the vehicle anchor 24 therein. The contours 72 formed in the opposite surfaces of the anchor opening 70 may abut one another and/or be directly aligned with the vehicle anchor 24, thereby restricting movement of the vehicle anchor 24 from the anchor opening 70. Application of a force to the anchor guide 40 in a direction away from the vehicle anchor 24 is sufficient to overcome the force acting on the first and second guide sidewalls 46, 48 and release the vehicle anchor 24 from the anchor guide 40.

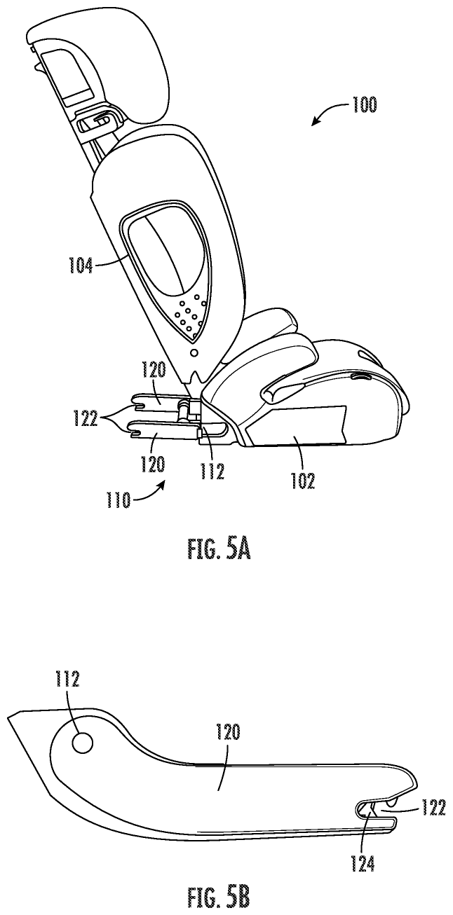

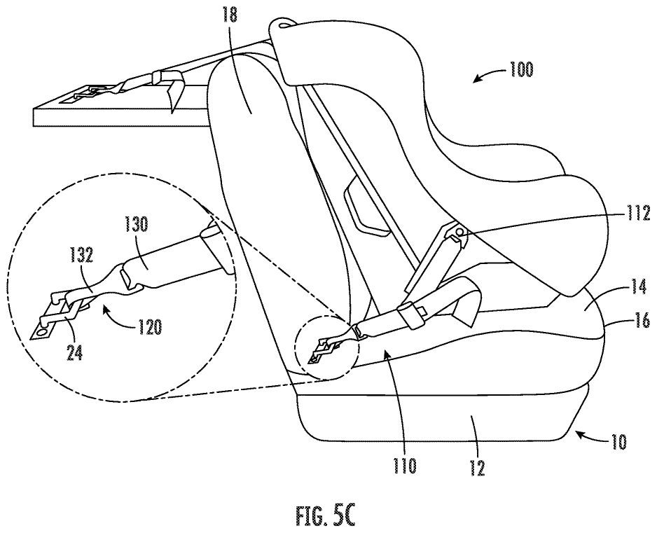

The child seat 100 positionable on the child seat underlay 30 may also detachably couple to the vehicle seat 10. For example, as shown in FIGS. 1 and 5A, the child seat 100 may include a seat portion 102 and a back portion 104. An anchor system 110 is coupled to the child seat 100, such as to the seat portion 102, near the interface with the back portion 104. The anchor system 110, sometimes referred to as a “lower anchor and tether for children” e.g., LATCH system, has one or more anchors 120 connectable to a vehicle anchor 24. It should be appreciated that embodiments where the child seat 100 does not include a back portion are also contemplated herein and therefore the position of the anchor system 110 may vary based on the configuration of the child seat 100.

The anchor system 110 may be an adjustable anchor system which may be formed of various rigid and/or flexible components that are adjustable relative to the seat portion 102. In other configurations, one or more components of the anchor system 110 may be fixed to and/or in position relative to the child seat 100. As shown in the non-limiting embodiments of FIGS. 5A and 5C, the anchor system 110 includes one or more anchors 120, each of which is movable, for example translatable and/or pivotable, relative to a respective constraining point 112 of the child seat 100. Although a mechanical constraining point is shown located at respective sides of the child seat 100, in other example implementations, the anchor system 110 may be coupled to the child seat 100 at one or more mechanical constraining points that are located at other positions about the child seat 100.

With reference to FIG. 5B, an example of an anchor 120 is illustrated in more detail. As shown, the anchors 120 may have an elongated shape (e.g., an oblong rectangle) having an opening 122 and include a locking mechanism (e.g., a latch) 124 that engages a corresponding vehicle anchor 24 in or proximate to the seat bight 20 of the vehicle seat 10. In this manner, the anchor system 110 may directly couple a child seat 100 to the vehicle seat 10. Although not shown, the anchors 120 may include (or be coupled to) a release mechanism (e.g., a button, a knob, a slidable tab) to unlatch the anchors 120 from the vehicle anchors 24 for separation of the child seat 100 from the vehicle seat 10. In various implementations, the anchors 120 and the vehicle anchors 24 may be configured to meet well-established safety standards and/or regulations, examples of which include, but not limited to, LATCH, ISOFIX, LUAS, and UCSS standards. It should be appreciated that the child seat 100 and corresponding anchors 120 illustrated and described herein are intended as an example only. It should be appreciated that any type of child seat 100, including a support base for a child seat 100 is within the scope of the disclosure. Further, an anchor 120 having any suitable configuration, such as a strap of piece of webbing 130 having a fastening member 132 connectable to the vehicle anchor 24 as shown in FIG. 5C for example, is within the scope of the disclosure.

When the child seat 100 is positioned on top of the child seat underlay 30, each of the one or more anchors 120 of the child seat 100 is receivable within the hollow interior 60 of a corresponding anchor guide 40. As best shown in FIG. 6, the overall size of the hollow interior 60 may be larger than the dimensions of the anchor 120 to allow for easy insertion of the anchor 120 into the anchor guide 40. However, in other embodiments, the hollow interior 60 may be sized to be substantially equal to or only slightly larger than the anchor 120, thereby minimizing float of the anchor 120 within the anchor guide 40. The hollow interior 60 may be contoured to align the opening of the anchor 120 with the anchor opening 70 formed in the anchor guide 40, thereby facilitating connection of the anchor 120 with the vehicle anchor 24.

A child seat underlay 30 upon which a child seat including an anchor system 110 is positionable as illustrated and described allows a user to easily install a child seat 100 within a vehicle and to properly secure the child seat 100 to the vehicle anchors 24.

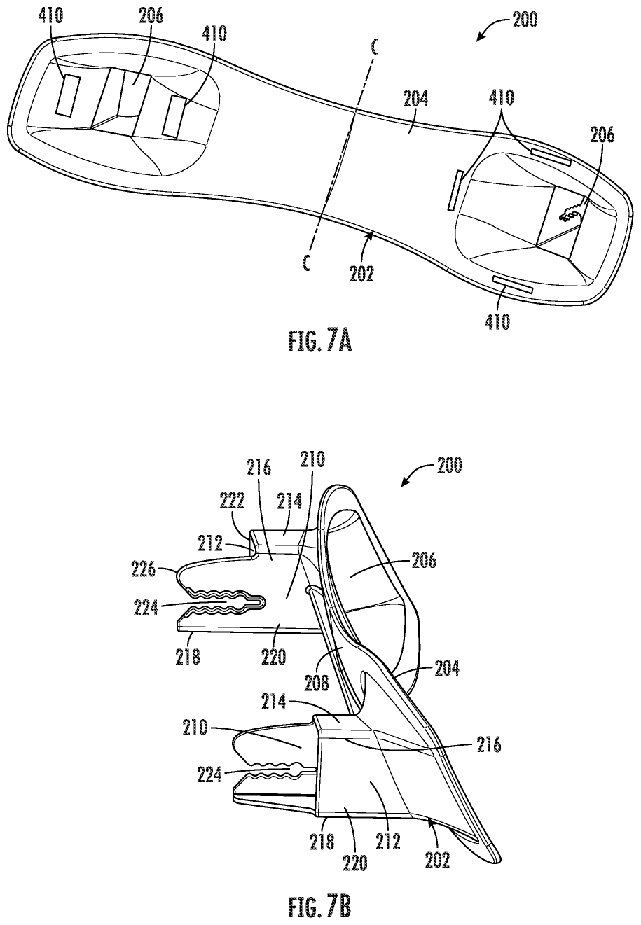

With reference now to FIGS. 7A and 7B, an example of another anchor guide 200 is illustrated. As the illustrated, non-limiting embodiment, the anchor guide 200 is a standalone piece, separate from a child seat underlay as previously described. However, embodiments where the anchor guide 200 is adapted for use with a child seat underlay are also contemplated herein. The anchor guide 200 includes a body 202 having a transverse member 204. A plurality of channels or openings 206 are formed in the transverse member 204 and each of the plurality of openings 206 is configured to receive a respective anchor 120 of a child seat 100 therein. In the illustrated, non-limiting embodiment, the number of openings 206 formed in the anchor guide 200 is equal to the number of anchors 120 associated with a child seat 100. For example, the anchor guide 200 is illustrated having a first opening 206 for receiving a first anchor 120 and a second opening 206 for receiving a second anchor 120. However, embodiments including additional openings for receiving additional anchors are also within the scope of the disclosure.

A plurality of walls extend from a back surface 208 of the transverse member 204 adjacent to each opening 206. As shown, the walls may include a first guide sidewall 210 and a second guide sidewall 212 spaced apart from one another. In the illustrated, non-limiting embodiment, a configuration of the first guide sidewall 210 is different than that of the second guide sidewall 212. However, embodiments where the first and second guide sidewalls are substantially identical are also contemplated herein. In an embodiment, at least one connecting wall extends between and couple the first and second guide sidewalls 210, 212. Similar to the previous embodiment, a first connecting wall 214 may be connected to an upper surface 216 of the first and second guide sidewalls 210, 212 and/or a second connecting wall 218 may be connected to a lower surface 220 of the first and second guide sidewalls 210, 212. As shown, the walls associated with each opening 206 of the anchor guide 200 may be substantially identical to one another. Further, as shown, the body 202 of the anchor guide 200, and specifically the walls may be symmetrical about a center line C of the anchor guide 200.

In the illustrated, non-limiting embodiment, a second end 222 of each of the second guide sidewall 212 and the first and second connecting walls 214, 218 is arranged within a plane, such as a plane oriented generally perpendicular to an axis of the opening for example. However, the first guide sidewall 210 may extend beyond the second end 222 of the second guide sidewall 212 and the first and second connecting walls 214, 218 in a direction away from the transverse member 204.

In an embodiment, at least one of the plurality of walls located adjacent to each opening 206, such as the first guide sidewall 210 for example, is connectable to a vehicle anchor 24. As shown, the first guide sidewalls 210 have an elongated anchor opening 224 for receiving a portion of a vehicle anchor 24 of a vehicle seat 10 therein. Similar to the first guide sidewall disclosed in the previous embodiment, one or more surfaces of the anchor opening 224 may be generally smooth, or in some embodiments may be contoured.

Further, the portion of the first guide sidewall 210 extending beyond the end 222 of the second guide sidewall 212 and the first and second connecting walls 214, 218 may be contoured to facilitate engagement with a vehicle anchor 24. For example, the upper surface 216 of the first guide sidewall 210 may taper generally downwardly from the transverse member 204 towards the second, opposite end 226 thereof. Further, the portion of the first guide sidewall 210 extending between the anchor opening 224 and the second end 226 may be contoured to facilitate insertion of the vehicle anchor 24 into the anchor opening 224. In the illustrated, non-limiting embodiment, the second end 226 of the first guide sidewalls 210 extending between the upper surface 216 and the anchor opening 224 is generally curved, and the second end 226 of the first guide sidewall 210 extending between lower surface 220 and the anchor opening 224 may be generally sloped or angled. It should be appreciated that embodiments where the second end 226 of the first guide sidewall 210 located adjacent to the anchor opening 224 have any suitable contour are within the scope of the disclosure.

When the anchor guide 200 is connected to a plurality of vehicle anchors 24 arranged within the seat bight 20 of a vehicle seat 10, a vehicle anchor 24 is arranged within the anchor opening 224 formed in each first guide sidewall 210. A force applied to one or both of the upper and lower surfaces 216, 220 of the first guide sidewall 210 may push the upper and lower surfaces of the first guide sidewall 210 towards one another, thereby capturing the vehicle anchor 24 therein. The contours of the anchor opening 224 may abut one another and/or be directly aligned with the vehicle anchor 24, thereby restricting movement of the vehicle anchor 24 from the anchor opening 224. Application of a force to the anchor guide 200 in a direction away from the vehicle anchor 24 is sufficient to overcome the force acting on the first guide sidewalls 210 and release the vehicle anchors 24 from the anchor guide 200.

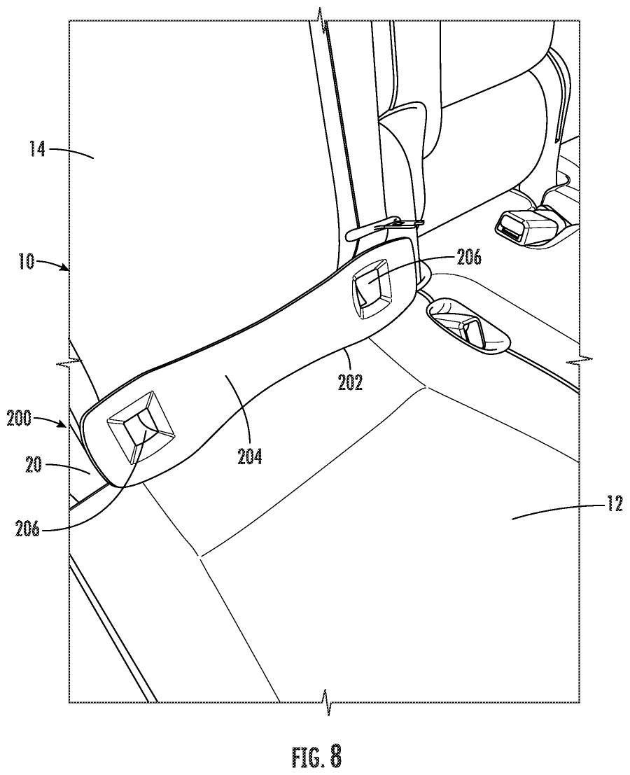

The anchor guide 200 may be connected to the vehicle anchors 24 prior to installation of the child seat about the vehicle seat 10. However, embodiments where the anchor guide is attached to the anchors of a child seat prior to connection to a vehicle anchor are also contemplated herein. As shown in FIG. 8, when the anchor guide 200 is connected to one or more vehicle anchors, the back surface of the transverse member of the anchor guide 200 may be in contact with the seat back of the vehicle seat. Accordingly, the anchor guide 200 can remain installed about a vehicle seat when a child seat is not present and will minimally obstruct an occupant seated directly on the vehicle seat.

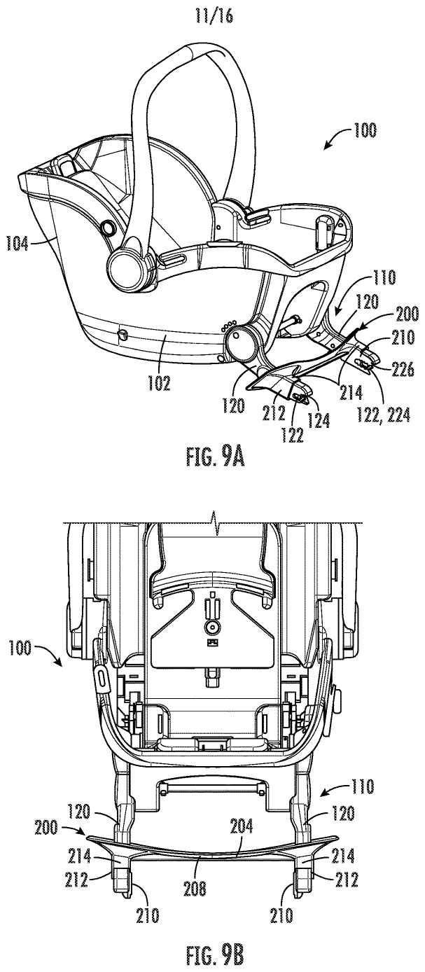

With reference to FIGS. 9A and 9B, each anchor 120 of a child seat 100 is receivable within a corresponding opening 206 formed in the anchor guide 200. In an embodiment, the cross-section of an opening 206 at the transverse member 204 may be larger than a cross-section of an anchor 120 to facilitate insertion of the anchor 120 into the opening 206. The dimensions of the openings 206 may be constant or may vary over the length of the opening. For example, the plurality of walls located adjacent to each opening 206 may be contoured such that a cross-sectional area of each opening 206 gradually decreases in a direction away from the transverse member 204. In the illustrated, non-limiting embodiment, the cross-sectional area of an opening 206 near a second end 222 of at least one of the plurality of walls associated with each opening 206 is generally equal to or is slightly larger than the cross-sectional area of an anchor 120 of a child seat 100 receivable therein. Alternatively, or in addition, the walls surrounding the opening 206 may be contoured to align the opening 122 of the anchor 120 with the anchor opening 22 formed in the first guide sidewall 210, thereby facilitating connection of the anchor 120 with the vehicle anchor 24.

By guiding the anchors 120 into position using the anchor guide 200, the user experiences an easier install while also protecting the seat bight and surrounding areas of the vehicle seat 10 from wear and tear associated with repeated connection and disconnection of the anchors 120 of the child seat 100.

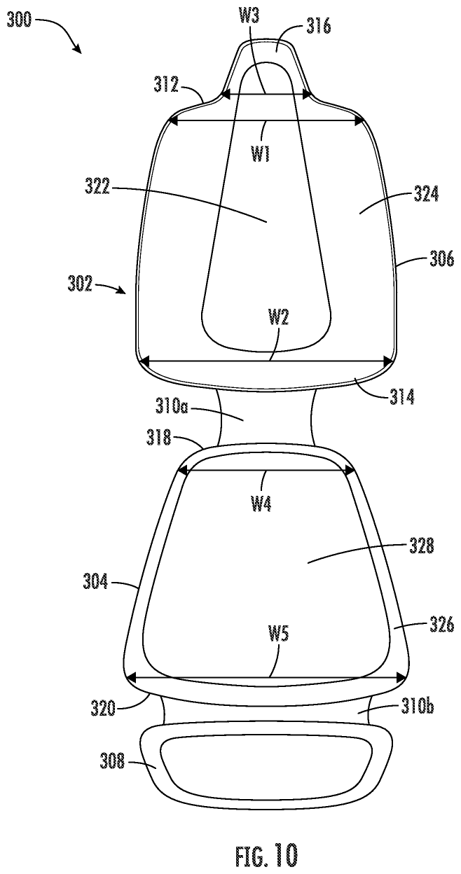

Another example of a child seat underlay 300 is illustrated in FIGS. 10-12C. Similar to the above embodiments, the child seat underlay 300 includes a body 302 having an axially aligned underlay seat portion 304 and an underlay back portion 306 as previously described. The underlay seat portion 304 and the underlay back portion 306 are coupled by a first connecting member 310a. In an embodiment, the underlay seat portion 304, the underlay back portion 306, and the first connecting member 310a are integrally formed as a unitary body. However, in other embodiments, such as shown in FIG. 10, the underlay seat portion 304 and the underlay back portion 306 may be formed as separate pieces and may be coupled to one another by the first connecting member 310a.

When mounted to a vehicle seat, such as vehicle seat 10 previously described herein, a portion of the body 302 may extend beyond an upper surface 14 of the generally horizontal seat portion 12 of a vehicle seat 10 to overlap a front edge 16 of the vehicle seat 10. This portion 308 of the body 302, also referred to herein as a “front flap”, may be connected to the underlay seat portion 304 by a second connecting member 310b. In an embodiment, the front flap 308, the second connecting member 310b, and the underlay seat portion 304 may be integrally formed. In other embodiments, the underlay seat portion 304 may be a separate component from the front flap 308 and may be coupled thereto by the second connecting member 310b. In an embodiment, at least one of the first connecting member 310a and the second connecting member 310b is formed from a flexible fabric material affixed, such as mechanically or chemically, to the adjacent components of the body 302. Use of a semi-rigid or flexible connecting member 310a, 310b, may allow the child seat underlay 300 to be folded or collapsed for storage.

In an embodiment, the underlay back portion 306 has a general trapezoidal shape with rounded edges. A width W1 (measured along a horizontal axis) of the underlay back portion 306 proximate to the upper end 312 thereof may be less than the maximum width W2 of the underlay back portion 306. The maximum width W2 of the underlay back portion 306 may be at a location at or near the lower end 314 positioned closest to the underlay seat portion 304. Further, a top guard 316 may be arranged at and extend from a central portion of the upper end 312 of the underlay back portion 306. This top guard 316 may be configured to overlap or align with the one or more arms of a vehicle head rest when the child seat underlay 300 is mounted about a vehicle seat 10. The top guard 316 may have a constant width over its length, or alternatively, may have a variable width over its length. In an embodiment, a maximum width W3 of the top guard 316 is less than the width W1 proximate the upper end 312 of the underlay back portion 306. For example, the maximum width W3 of the top guard 316 may be less than or equal to 50% of the width W1 at the upper end 312 of the underlay back portion 306.

The underlay seat portion 304 may be generally trapezoidal in shape with rounded edges. Similar to the underlay back portion 306, a width W4 of the underlay seat portion 304 proximate to the upper edge 318 positioned closest to the underlay back portion 306, may be smaller than the maximum width W5 of the underlay seat portion 304. The maximum width W5 of the underlay seat portion 304 may be at a location proximate to the lower end 320 of the underlay seat portion 304. The taper of the sides of the underlay seat portion 304 may be greater than that of the underlay back portion 306. Further, the maximum width W5 of the underlay seat portion 304 may be equal to, and in some embodiments greater than the maximum width W2 of the underlay back portion 306.

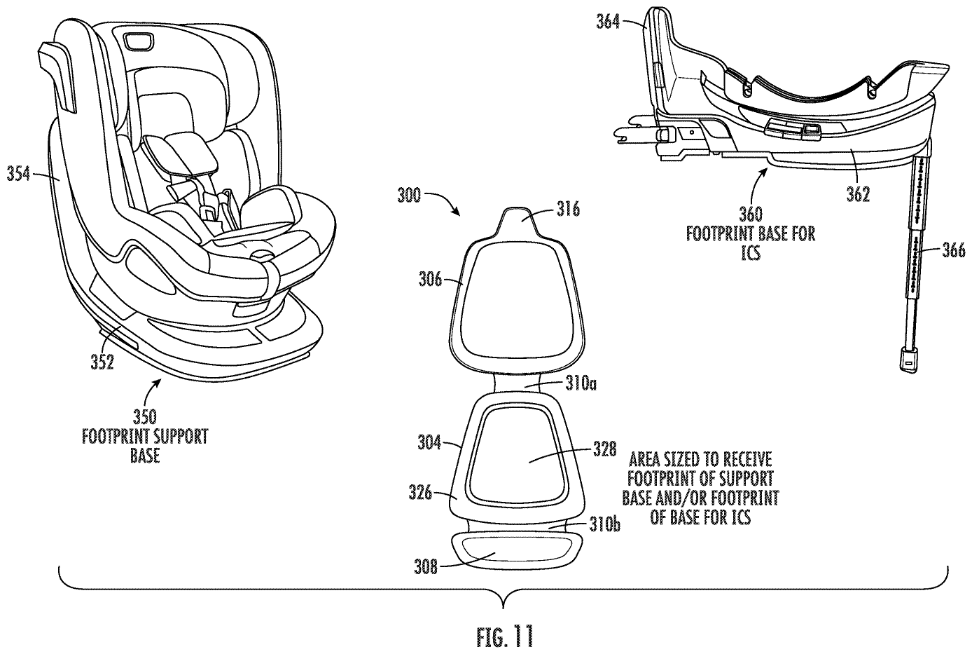

In an embodiment, the underlay seat portion 304 is sized and shaped to receive a corresponding portion of a child seat 100 thereon. For example, a footprint of a support base integrally formed with a child seat, identified at 350 in FIG. 11, is positionable in its entirety or substantial entirety within the boundary of the outer periphery of the underlay seat portion 304. The support base 350 may include a seat portion 352 and a back portion 354 and in some embodiments, the footprint is substantially defined by the seat portion 352. Alternatively, or in addition, the footprint of a base configured to removably couple to an infant car seat, identified at 360 in FIG. 11, may be positionable in its entirety or substantial entirety within the boundary of the outer periphery of the underlay seat portion 304. In the illustrated, non-limiting embodiment, the base 360 includes a seat portion 362 and a back portion 364, the back portion 364 extending a minimal height above the seat portion 362. However, embodiments including an elongated back portion 364, such as a back portion 364 that extends over at least 50% of the height of the vehicle seat 10 for example, are also contemplated herein. As shown, the base 360 may include a stability leg 366. When the base 360 is positioned on the underlay seat portion 304, the stability leg 366 may be arranged forward of the underlay seat portion 304, and in some embodiments may contact the front flap 308 of the child seat underlay 300. However, it should be appreciated that in some embodiments, the base 360 does not include a stability leg 366.

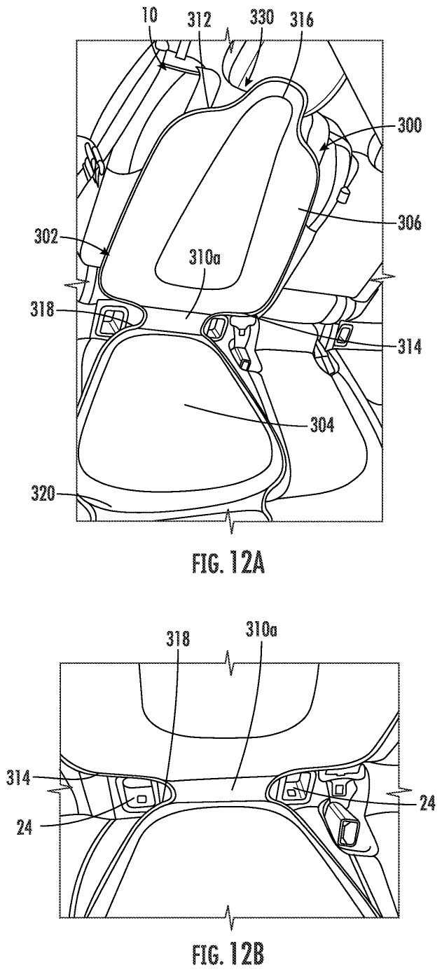

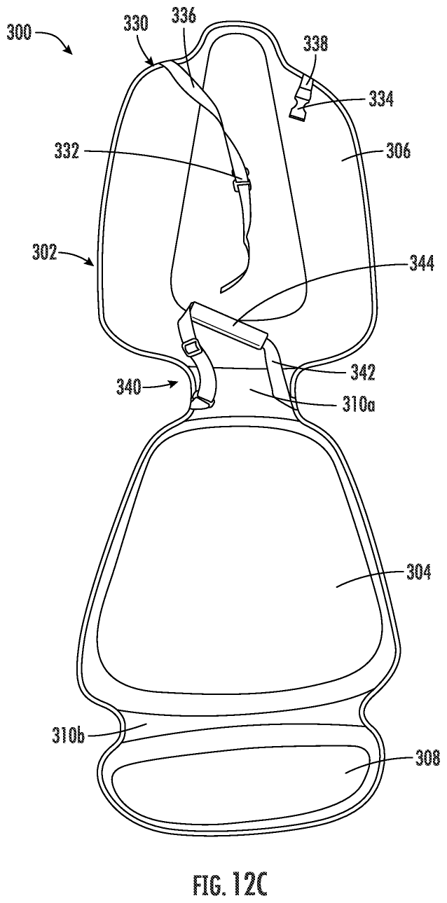

A width of the first connecting member 310a extending between and connecting the underlay seat portion 304 and the underlay back portion 306 may be less than the widths (W1, W2, W4, W5) of both the sized to underlay seat portion 304 and the underlay back portion 306. When the child seat underlay 300 is mounted about a vehicle seat 10, the first connecting member 310a is positioned adjacent to the interface between the generally horizontal seat portion 12 and the seat back 18 of the vehicle seat 10. As shown in FIG. 12B, the first connecting member 310a may be generally aligned with the vehicle anchor 24 of a vehicle seat 10. Accordingly, in an embodiment, the width of the first connecting member 310a is less than a width defined between a pair of vehicle anchors 24 associated with a given vehicle seat so that the first connecting member 310a does not inhibit access to the vehicle anchors 24.

In an embodiment, at least a portion of the body 302 facing away from the vehicle seat 10 has a contoured or sculpted surface. For example, a central region 322 of the underlay back portion 306 may be raised relative to the adjacent portion 324 of the underlay back portion 306. Alternatively, or in addition, the underlay seat portion 304 may have a raised lip 326 arranged about its perimeter at the outer edge thereof. The lip 326 may have a gradual or contour to avoid sharp edges formed in the body 302. In such embodiments, a central portion 328 of the underlay seat portion 304 may be recessed relative to the outer edge thereof. In embodiments where the outer periphery of the underlay seat portion 304 is contoured, the underlay seat portion 304 may be sized and shaped to such that a footprint of a support base of a child seat, such as support base 350 for example, or a footprint of a base configured to removably couple to an infant car seat, such as base 360 for example, is positionable within the recess 328 defined by the raised edge 326. It should be understood that the contour configurations illustrated and described herein are intended as an example only and that an underlay seat portion 304 or an underlay back portion 306 having another contour is also within the scope of the disclosure.

In an embodiment, one or more contours may be formed in one the body 302 via stitching at an upper surface of the body 302. In other embodiments, at least a portion of the body 302 of the child seat underlay 300 is a thermoformed structure, such as a thermoformed fabric material for example. A material such as fabric can be manipulated during a thermoforming process to form one or more of the contours of the underlay seat portion 304 and/or the underlay back portion 306 described herein. In some embodiments, a core, such as a formed from plastic, foam, or an elastic polymer such as ethylene vinyl acetate for example, may be used in combination with the thermoformed structure. Such a core may be arranged at an interior of a thermoformed body, such as within a cavity formed by the thermoformed structure. For example, a core may be positioned within the central region 322 of the underlay back portion 306. Inclusion of a core may assist in retaining the shape of the body when a force is applied thereto.

With reference to FIGS. 12A and 12C, in an embodiment, the child seat underlay 300 includes at least one attachment assembly for affixing the child seat underlay 300 to the vehicle seat 10. As shown, an attachment assembly 330 may include a connection mechanism including a first portion 332 and a complementary second portion 334. The first portion 332 of the connection mechanism may be mounted directly to the body 302 of the child seat underlay 300, or alternatively, may be movably coupled thereto such as via a strap or piece of webbing 336. Similarly, the second portion 334 of the connection mechanism may be mounted directly to the body 302 of the child seat underlay 300, or alternatively, may be movably coupled thereto such as via a strap or piece of webbing 338. In the illustrated, non-limiting embodiment, the first portion 332 is a male buckle movably coupled to the upper end 312 of the underlay back portion 306 via a first piece of webbing 336 and the second portion 334 is a female buckle movably coupled to the upper end 312 of the underlay back portion 306 via a second piece of webbing 338. As shown, the first and second pieces of webbing 336, 338 may be connected to the underlay back portion 306 at opposite sides of the top guard 316. In such embodiments, the top guard 316 may be operable to protect the vehicle seat 10 from damage caused by the attachment assembly 330.

The first piece of webbing 336 and the male buckle 332 may wrap about an anchor of the vehicle seat, a headrest itself, or at least one headrest arm connecting the headrest to the vehicle seat 10, to couple to with the female buckle 334. The resulting connection between the male and female buckle restricts separation of the child seat underlay from the vehicle seat. Although the connection mechanism illustrated in the non-limiting embodiment is a buckle, embodiments including another type of connection mechanism, such as a fastener and nut, a hook and loop fastener, magnets, snaps, rivets etc., are also contemplated herein.

In an embodiment, an attachment assembly 340 including a piece of webbing 342 may be affixed to the body 302, such as at or near the first connecting member 310a. The webbing 342 may be attached at both a first end and a second opposite end to the body of the child seat underlay 300. However, embodiments where one or more of the ends of the webbing 342 is separable from the body are also contemplated herein. The webbing 342 may be connectable to the vehicle seat 10, such as at or near the seat bight 20. Further, in some embodiments, a handle 344 may be coupled to the webbing 342 to provide a user with a location to easily grasp and apply a force to the child seat underlay 300. The webbing 342 and/or the handle 344 may be inserted into the seat bight 20 to couple the child seat underlay 300 to the vehicle seat 10. Friction between the vehicle seat 10 and the webbing 342 and/or the handle 344 in combination with the resiliency of the vehicle seat 10 may restrict separation of the webbing 342 and/or handle 344 from the seat bight 20.

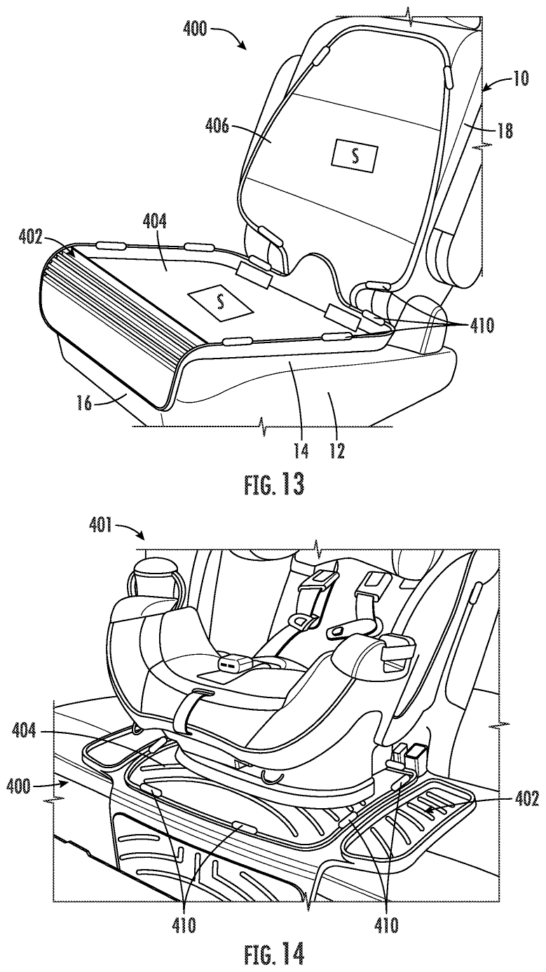

With reference now to FIGS. 13 and 14, another embodiment of a child seat underlay 400 positionable on a vehicle seat, such as seat 10 the vehicle seat 10 is illustrated. As shown, the child seat underlay 400 has a body 402 including an underlay seat portion 404 positionable between a bottom of the child seat, such as child seat 401 shown in FIG. 14 and a corresponding surface 14 of the vehicle seat 10 and an underlay back portion 406 positionable between the seat back of the child seat 401 and a corresponding seat back 18 of the vehicle seat 10. It should be appreciated that the child seat underlay 400 may have any configuration as previously described herein.

In the illustrated, non-limiting embodiment, one or more lights 410 are coupled to or embedded within a portion of a child seat underlay, such as child seat underlay 400. The at least one light 410 may be arranged at any position about the child seat underlay 400 that is not typically covered by a child seat 401, and therefore is visible to a user. As shown, a plurality of lights 410 may be positioned about a border or proximate to an edge of the underlay seat portion 404 and/or the underlay back portion 406. In embodiments including a plurality of lights 410, the lights 410 may extend continuously about the periphery or may be uniformly or non-uniformly spaced about the periphery. However, embodiments where the lights 410 are arranged at another location about the child seat underlay 400 are also contemplated herein. Alternatively, or in addition, one or more lights may be positioned near an attachment assembly, such as attachment assembly 330 for example. In an embodiment, a light 410 may be arranged at a portion of the child seat underlay 400 proximate to a vehicle seat anchor. In an embodiment, the lights 410 are oriented to direct light upwards, such as toward a child seat receivable thereon, or toward an interface between the body of the child seat underlay 400 and the child seat. In an embodiments, one or more lights 410 are oriented to direct light towards a vehicle anchor and/or towards an attachment assembly of the child seat underlay 400.

In embodiments where the child seat underlay includes at least one anchor guide, such as child seat underlay 30 including anchor guides 40 for example, one or more lights 410 may be mounted at or adjacent to the anchor guides 40. For example, in the non-limiting embodiment of FIG. 4A, one or more lights 410 may be arranged at the hollow interior 60 of the anchor guide 40, such as at one or more of the first connecting wall 50, the second connecting wall 56, the first guide sidewall 46 and the second guide sidewalls 48. Alternatively, or in addition, in some embodiments, one or more lights 410 may be arranged proximate to or at an end of one or more of the plurality of walls 46, 48, 50, 56. In embodiments where the anchor guide 40 includes a flange 62, one or more lights 410 may be positioned adjacent to the flange 62 of the anchor guide 40.

Further, it should be understood that even in embodiments where an anchor guide is not associated with a child seat underlay, such as anchor guide 200 for example, the anchor guide 200 may have one or more lights 410 mounted thereon or embedded therein to facilitate the connection of a latch of an anchor system with a vehicle anchor 24. In the non-limiting embodiment illustrated in FIG. 7A, one or more lights 410 may be arranged at the transverse member 204, such as adjacent to one of the plurality of openings 206 formed therein. Alternatively, or in addition, one or more lights 410 may be arranged at or embedded within one or more of the first guide sidewall 210, the second guide sidewall 212, the first connecting wall 214 and second connecting walls 218 formed in a respective opening 206 to illuminate the interior of the anchor guide 200.

Regardless of the configuration of the child seat underlay 30, 300 or the anchor guide 60, 200, the at least one light 410 may be manually operable to activate and deactivate the at least one light 410. Alternatively, or in addition, the one or more lights 410 can be operably connected to one or more sensors, illustrated schematically at S (see FIG. 13). The one or more sensors S can be positioned on or about the child seat underlay 400, the vehicle seat 10, a surface of the anchor guide 40, 200 or at any other suitable location. The one or more sensors S can include, for example, a proximity sensor, a pressure sensor, or other sensor for sensing a proximity of the child seat 401 to the child seat underlay 400, a movement of a component of the child seat 401 on the child seat underlay 400, or for sensing other situations or actions. In response to an input to the sensor, the sensor will transmit a signal to one or more lights 410. Accordingly, the one or more lights 410 may be automatically activated and/or deactivated in response to a signal generated by a sensor S. Inclusion of lights into the child seat underlay 400 may provide a user with greater visibility during installation and removal of the child seat 401 from the transportation device and during installation and separation of a child from the child seat 401.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A child seat underlay upon which a child seat including an anchor system is positionable, the child seat underlay being positionable on a vehicle seat with a vehicle anchor, the child seat underlay comprising:
a body positionable to overlap a surface of the vehicle seat; and
at least one anchor guide associable with said body, said at least one anchor guide being connectable to the vehicle anchor of the vehicle seat.

2. The child seat underlay of claim 1, wherein said body further comprises an underlay seat portion, said underlay seat portion being positionable on a horizontal seat portion of the vehicle seat.

3. The child seat underlay of claim 2, wherein an end of said underlay seat portion extends beyond a front edge of said horizontal seat portion of the vehicle seat.

4. The child seat underlay of claim 2, wherein said at least one anchor guide is mounted at a rear end of said underlay seat portion.

5. The child seat underlay of claim 2, wherein said body further comprises an underlay back portion, said underlay back portion being positionable adjacent to a seat back of the vehicle seat.

6. The child seat underlay of claim 5, wherein said underlay back portion is permanently connected to said underlay seat portion.

7. The child seat underlay of claim 5, wherein said underlay back portion is removably couplable to said underlay seat portion.

8. The child seat underlay of claim 7, wherein said at least one anchor guide is mounted at an interface between said underlay seat portion and said underlay back portion.

9. The child seat underlay of claim 1, wherein said at least one anchor guide is permanently attached to said body.

10. The child seat underlay of claim 1, wherein said at least one anchor guide is removably connectable to said body.

11. The child seat underlay of claim 10, wherein said body includes at least one opening, said at least one anchor guide being insertable into said at least one opening.

12. The child seat underlay of claim 11, wherein said at least one anchor guide includes a mounting flange, said mounting flange being positionable against said body surrounding said at least one opening.

13. The child seat underlay of claim 1, wherein said at least one anchor guide includes an anchor guide body having a hollow interior, said hollow interior being dimensioned to receive an anchor of the anchor system extending from the child seat.

14. The child seat underlay of claim 13, wherein the child seat is an infant car seat.

15. The child seat underlay of claim 13, wherein the child seat is a toddler seat.

16. The child seat underlay of claim 13, wherein the child seat is a booster seat.

17. The child seat underlay of claim 13, wherein the child seat includes a support base, the anchor extending from said support base.

18. The child seat underlay of claim 13, wherein said anchor guide body includes a first guide sidewall and a second guide sidewall spaced from said first guide sidewall, each of said first guide sidewall and said second guide sidewall having an anchor opening for receiving the vehicle anchor of the vehicle seat.

19. The child seat underlay of claim 1, further comprising at least one light arranged at one or more of said at least one anchor guide and said body.

20. The child seat underlay of claim 19, wherein the at least one light is automatically activatable in response to an input from a sensor, the sensor being arranged at the body.

21. The vehicle seat protector of claim 20, wherein the sensor is a pressure sensor.

22. The vehicle seat protector of claim 20, wherein the sensor is a proximity sensor.

23. The vehicle seat protector of claim 19, wherein the at least one light is manually operable.

24.-72. (canceled)
